(19) United States
(12) Patent Application Publication
(10) Pub. No.: US 2026/0089735 A1
(43) Pub. Date: Mar. 26, 2026

(54) SEARCH SPACE CONFIGURATIONS AND PDCCH MONITORING WITH MULTI-CELL SCHEDULING DCI

(71) Applicant: Apple Inc., Cupertino, CA (US)

(72) Inventors: Sigen Ye, San Diego, CA (US); Dawei Zhang, Saratoga, CA (US); Wei Zhang, Santa Clara, CA (US); Ankit Bhamri, Haar (DE); Chunhai Yao, Beijing (CN); Wei Zeng, Saratoga, CA (US); Huaning Niu, San Jose, CA (US); Chunxuan Ye, San Diego, CA (US)

(21) Appl. No.: 19/108,776

(22) PCT Filed: Sep. 30, 2022
(86) PCT No.: PCT/CN2022/123224

§ 371 Date: Mar. 5, 2025

(51) Int. Cl. H04W 72/232; H04W 72/1273

(52) U.S. Cl. CPC H04W 72/232; H04W 72/1273

(57) ABSTRACT

Techniques discussed herein can facilitate configuring search spaces for physical downlink shared channel (PDCCH) candidates for multi-cell (mc) downlink control information (mcDCI) that schedules multi-cell communications. One example aspect is a baseband processor of a user equipment (UE), comprising a memory; and one or more processors configured to, when executing instructions stored in the memory, cause the UE to receive radio resource control (RRC) signaling configuring control channel element (CCE) offset indicators mapped to respective search space sets and respective component carriers (CCs), where each CC is associated with a scheduled cell of one or more scheduled cells. The one or more processors are further configured to determine, based on the RRC signaling, CCE resources associated with one or more physical downlink control channel (PDCCH) candidates, perform blind decoding of the one or more PDCCH candidates to decode one or more multi-cell downlink control information (mcDCI) transmitted by a scheduling cell, and determine, from the one or more mcDCI, uplink (UL)/downlink (DL) CCs.

### FIELD

The present disclosure relates to wireless communication networks and mobile device capabilities.

### BACKGROUND

Mobile communication in the next generation wireless communication system, 5G, new radio (NR), sixth generation technology, and so on will provide ubiquitous connectivity and access to information, as well as the ability to share data, around the globe. Next generation wireless communication systems provide service-based framework that will target to meet versatile, and sometimes conflicting, performance criteria. Such technology may include solutions for scheduling data over multiple cells.

### BRIEF DESCRIPTION OF THE DRAWINGS

FIG. 1 illustrates an example wireless network where wireless devices configure and perform multi-cell communications.

FIG. 2 is a diagram illustrating examples of control channel element (CCE) offset indicator mapping.

FIGS. 3A and 3B show example scenarios to demonstrate per cell limits for blind decodes and CCE resources for multi-cell resource scheduling.

FIGS. 4 and 5 show example mapping diagrams of multi-cell configuration data for various aspects described herein.

FIG. 6 is a flow diagram illustrating an example method by which a user equipment (UE) can configure multi-cell communications.

FIG. 7 is a flow diagram illustrating an example method by which a base station (BS) can configure multi-cell communications.

FIG. 8 illustrates an example of an infrastructure equipment, in accordance with various aspects disclosed.

FIG. 9 illustrates an example of a UE or BS platform, in accordance with various aspects disclosed.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

The present disclosure relates to configuring search spaces for physical downlink shared channel (PDCCH) candidates for multi-cell (mc) downlink control information (mcDCI) that schedules multi-cell communications. Techniques discussed herein relate to multi-cell configuration of control channel elements (CCEs), search spaces, and component carriers to decode the mcDCI for a user equipment (UE) to achieve flexibility and spectral efficiency for scheduling multi-cell uplink (UL) and downlink (DL) data signaling.

Wireless networks support a wide range of spectrum use in different frequency bands. Wireless networks can configure search spaces for monitoring of PDCCH candidate to efficiently use the available spectrum. In some aspects, the wireless spectrum can be scattered and communications needs can demand wider bands or more bands across the scattered spectrum to achieve spectral or power efficiency in a flexible manner. Current scheduling mechanisms fully support a single-cell scheduling using a PDCCH candidate through a single-cell DCI (scDCI). Depending on spectrum use, traditional search space scheduling and monitoring of PDCCH candidates indicated by a scDCI can result in significant scheduling overhead to schedule wide band operations across multiple cells and/or over a scattered spectrum as multiple scDCI are signaled to schedule such spectrum use. To reduce control signaling overhead, it is beneficial to extend from single-cell scheduling to multi-cell scheduling by use of multi-cell DCI (mcDCI).

Various aspects of the present disclosure are directed towards multi-cell communications where multi-cell scheduling data is used by a UE to decode a PDCCH candidate carrying mcDCI and configure multi-carrier uplink and downlink signaling for wide-band, multi-band, or spectral efficiency needs. Mechanisms by which search spaces are configured for component carriers (CCs) of one or more scheduled cells are presented herein. Mechanisms by which control channel elements (CCEs) associated with the scheduled cells are determined for PDCCH candidates for mcDCI are presented herein. The mcDCI can indicate to the UE CCs of scheduled cells for UL and DL data signaling. The multi-cell scheduling resources enable the UE to establish communications with multiple cells with minimal scheduling overhead based on the mcDCI. Mechanisms by which a maximum number of blind decodes and/or a maximum number of CCEs are configured based on each serving cell are presented herein. By limiting the blind decodes required and/or CCEs configured for each serving cell, the complexity and power consumption required by the UE to monitor for the PDCCH candidates is minimized or controlled according to timing and power budgets. Mechanisms by which the size of the mcDCI is configured to meet signaling overhead requirements are presented herein.

Aspects presented herein provide flexibility and spectral efficiency by minimizing signaling overhead to schedule multi-cell communications by use of the mcDCI and multi-cell scheduling configuration.

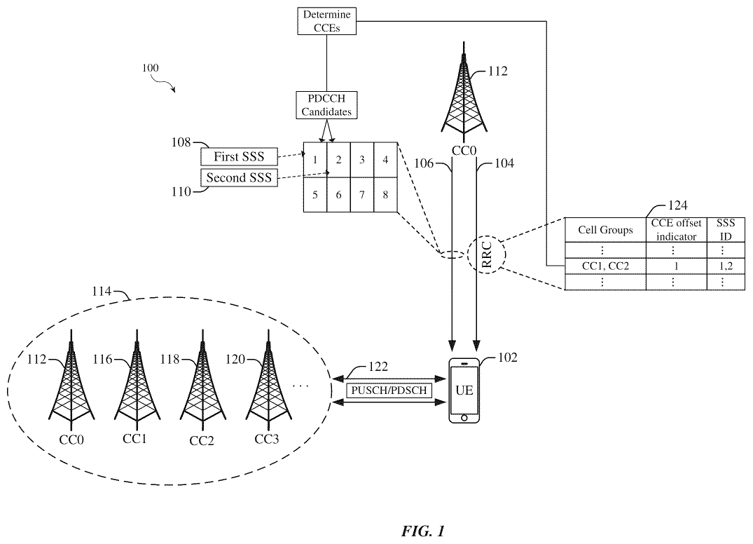

FIG. 1 illustrates an example wireless network 100 where wireless communication devices (e.g., UEs, base stations (BSs), or generic devices) configure and perform multi-cell communications. The UE in the network (e.g., UE 102) includes baseband circuitry that includes one or more processors configured to perform various types of multi-cell signaling and configuration. For the purposes of this description, when a “UE” or “device” is described as performing some function, it can be understood that it is the processor(s) in the baseband circuitry, in conjunction with memory and/or transceivers(s) in some instances, that perform the function. An example wireless communication device, including baseband circuitry, is illustrated in more detail in FIG. 9.

The example wireless network 100 includes a BS 112 that configures a signal 104 that includes a mapping of multi-cell configuration data for the UE 102. In some examples, the signal 104 is a radio resource control (RRC) signal. RRC signaling provides a control mechanism for the BS 112 and the UE 102 to dynamically change cellular configurations and communicate data. In some aspects, RRC signaling can be layer 3 signaling. The multi-cell configuration data can include CCE offset indicators mapped to respective search space sets and respective CCs, where each CC is associated with a scheduled cell of one or more scheduled cells. The UE 102 determines CCE resources, for example, time/frequency resources and index location, based on the RRC signaling. The CCE resources are related to one or more PDCCH candidates.

The BS 112 configures a signal 106 with one or more mcDCI. Since the BS 112 generates and transmits mcDCI, the BS 112 can be referred to as a scheduling cell or a scheduling BS. While BS 112 is illustrated as transmitting both the multi-cell configuration data at 104 and the mcDCI at 106, a different BS or cell may transmit the multi-cell configuration data at 104. The UE 102 performs blind decoding of the one or more PDCCH candidates to decode the one or more mcDCI in the signal 106. The signal 106 can be a layer 1 signal. Subsequently, the UE 102 determines, from the one or more mcDCI, one or more UL/DL CCs of the CCs configured in the multi-cell configuration data. The UE 102 configures the UL/DL CCs for UL/DL data signaling 122, for example, physical downlink shared channel (PDSCH) or physical uplink shared channel (PUSCH).

PDCCH carries DCI (e.g., mcDCI) including UL and/or DL scheduling and control information and configurations, for example, downlink scheduling commands, uplink scheduling grants, and uplink power control commands. The DCI is mapped onto the PDCCH over a number of resource elements (RE) corresponding to one of the candidates for an aggregation level. The aggregation level is associated with a number of CCEs (e.g., CCE resources) where a CCE can be equivalent to a number of resource element groups (REG) (e.g., 1 CCE=6 REG, 1 REG=72 REs).

DCI carried in PDCCH provides scheduling information for downlink data channels (e.g., PDSCH) and/or uplink data channels (e.g., PDSCH). The DCI communicates what resource blocks carry payload data, instructions for demodulating or decoding data such that the UE 102 can receive and decode payload data. In legacy systems, the DCI can be described as a single-cell DCI (scDCI), where the scDCI is associated with DL/UL scheduling and control associated with a single cell, or single BS, or single component carrier (CC) of a single cell. In aspects described herein, the DCI can be used for multi-cell scheduling and the DCI is described as a mcDCI. In this aspect, the mcDCI is associated with DL/UL scheduling and control associated with multiple cells or multiple component carriers (CCs) of multiple cells. It is noted that a UE may be configured to search for one or more mcDCI and one or more scDCI at the same time.

The one or more PDCCH candidates are mapped onto a search space set. The search space set can be assigned for different purposes such as periodicity based on a search space set type (e.g., Type 0, 0A, 1, 2, 3, UE specific, etc.). The search space set is mapped to a control resource set (CORESET) that specifies the set of REs and number of symbols for the search space set. The CORESET defines the specific resource blocks and symbols on which the UE 102 attempts to perform a blind decode on a PDCCH candidate. A blind decode refers to decoding a PDCCH candidate where the PDCCH candidate may or may not include the mcDCI.

Blind decoding within the search space set can be a considerable cost of resources to the UE 102. As such, the number of blind decodes are limited to conserve resources. For example, the blind decoding is limited on a per scheduled cell basis according to a maximum number of PDCCH candidates per slot which can be a function of subcarrier spacing (SCS). For example, high SCS provide less time for the UE 102 to complete a search since slots are shorter. Thus the number of blind decodes can be limited by the SCS, for example a 44 blind decode limit for a 15 kHz SCS, or a 20 blind decode limit for a 120 KHz SCS. The number of blind decodes are distributed across a range of configured aggregation levels.

The UE 102 can perform channel estimation per slot of the serving cell (e.g., BS 112) for a CCE resource since the PDCCH candidates can be configured with a demodulation reference signal (DMRS) or a cell specific reference signal for channel estimation. As such, for each CCE resource, there is a limited time to perform channel estimation according to the DMRS or cell specific reference signal based on the SCS. To manage resources, a CCE limit can be applied, for example, based on the SCS. For example, the CCE limit can be 56 for a 15 KHZ SCS, or 32 for a 120 KHz SCS. For multi-carrier scheduling, the blind decode limit and the CCE limit should accommodate search space sets and CCs as scheduled by one or more of scDCI and mcDCI, as described herein.

In some examples the multi-cell configuration data communicated in signal 104 is comprised in a cross carrier scheduling configuration (crossCarrierSchedulingConfig), a search space configuration, or the like. The multi-cell configuration data can include a resource table 124 representing the mapping of cell groups represented by associated CCs, CCE offset indicators, and optionally the set of search space set. The CCs can be arranged in cell groups. The cell groups can be collectively referred to as scheduled cells. In some aspects, a set of search space set are not mapped to the cell groups. For example, the resource table 124 may not be configured with SSS ID for the cell groups. When the set of search space set are not mapped to the cell groups, then all search space sets configured for the mcDCI can be applicable to the cell groups. In the illustrated example, the scheduled cells correspond to CC1 and CC2, the CCE offset indicator is 1, and the set of search space sets include SSS ID 1 and SSS ID 2. A SSS ID is an ID of a search space set. In some aspects discussed herein, the search space set associated with the CCE offset indicator is a common search space set for the cell group, as such, the SSS ID may indicate the common search space set. The CCE offset indicator is a parameter used in conjunction with at least the SSS ID to determine the resources for one or more CCEs associated with the one or more PDCCH candidates. In some examples, the CCE offset indicator is associated with a carrier indicator field (CIF) value from the cross carrier scheduling configuration.

Cross-carrier scheduling refers to when resources received by a first carrier provide a resource allocation for a second carrier. For example, the UE 102 can receive the PDCCH candidate resources from a component carrier (e.g., CC0) of BS 112 (e.g., scheduling BS), and the PDCCH can include a mcDCI that provides resource allocations (e.g. for UL/DL data signaling 122) for another component carrier (e.g., CC1) of BS 116 (e.g., scheduled cell). In some aspects, for cross-carrier scheduling of a scheduled cell, the CCEs for the configured number of PDCCH candidates for an aggregation level are determined by Equation 1 below. Equation 1 can be used to determine an index of the CCEs of PDCCH candidates so that the UE 102 can identify where the PDCCH candidates are located in the search space set.

$$L \{ ( {Y}_{p , {n}_{s , f}^{μ}} + [ \frac{{m}_{s , {n}_{CI}} \cdot {N}_{CCE , p}}{L \cdot {M}_{s , max}^{( L )}} ] + {n}_{CI} ) mod [ {N}_{CCE , p} / L ] \} + i \qquad Equation 1$$

In Equation 1, L represents the aggregation level (e.g., 1 through 16).

$${Y}_{p , {n}_{s , f}^{μ}}$$

represents a hash function. When the hash function is for a common search space (CSS), the hash function value is zero. When the hash function is for a UE search space (USS), the hash function value is based on a radio network temporary identifier (RNTI). m_{s,n}_{_{CI}} represents an index of the PDCCH candidate amongst

$${M}_{s , max}^{( L )} .$$

N_{CCE,p} represents a number of CCEs for a CORESET “p” associated with the PDCCH candidate.

$${M}_{s , max}^{( L )}$$

represents a number of PDCCH candidates for the aggregation level L in an associated search space set. n_{CI} represents the CCE offset indicator. In some aspects, n_{CI} corresponds to a value in a carrier indicator field (CIF) from a cross carrier scheduling configuration (CrossCarrierSchedulingConifg) information element (IE) in a DCI (e.g., scDCI or mcDCI). The CIF value can indicate scheduling and/or resource information for cross-carrier scheduling. i represents an index of the CCE among aggregation level L. The CCE offset indicator is used to determine an index for the CCE of a CC. For example, for different values of n_{CI} of Equation 1, there are different indices for each of the CCE of the aggregation level. The variables of Equation 1 can be received according to RRC signaling or other signaling before receiving the one or more PDCCH candidates associated with signal 106.

FIG. 1 illustrates signal 106 as including search space sets with SSS IDs 1-8. The BS 112 configures one or more mcDCI in one or more PDCCH candidates in at least one of the search space sets, for example, first search space set 108 indicated by SSS ID 1 or a second search space set 110 indicated by SSS ID 2 in signal 106. The UE 102 may receive the multi-cell configuration data (e.g., resource table 124) from a different cell than the scheduling cell (e.g., BS 112) from which the one or more PDCCH candidates are received.

The UE 102 can receive one or more PDCCH in the first search space set 108 or the second search space set 110 comprising the one or more mcDCI. The one or more mcDCI include multi-cell scheduling information that the UE 102 uses for UL/DL data signaling 122 over one or more component carriers (CCs) of scheduled cells. In the illustrated example, the scheduled cells include a set of scheduled BSs 114 (e.g., BS 116 configured for CC1, BS 118 configured for CC2, and BS 120 configured for CC3). Furthermore, scheduled cells can include the scheduling cell (e.g., BS 112 configured for CC0). After the UE 102 receives the one or more mcDCI, the UE 102 determines which cells are configured for UL/DL communications. For example, the mcDCI may schedule a transfer of data between the UE and the indicated cell group such that data transfer is scheduled on one or both of CC1 and CC2.

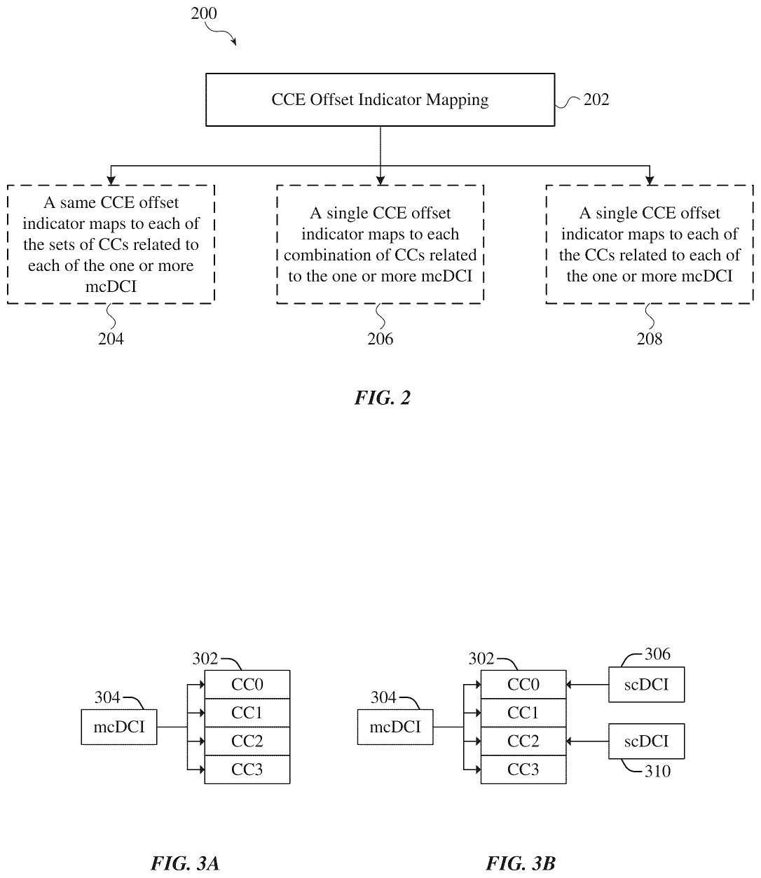

FIG. 2 is a diagram 200 illustrating examples of CCE offset indicator mapping. Aspects of diagram 200 are applicable to FIG. 1. For example, the CCE offset indicator mapping of diagram 200 can correspond to the mapping captured in the CCE offset indicator of resource table 124 of signal 106. The BS 112 can configure the mapping of the CCE offset indicators at 202 to one or more mcDCI and CCs according to various options. As such, when the UE 102 receives resource table 124 and the signal 106, the one or more mcDCI of signal 106 are carried by CCEs indicated by mapped CCE offset indicators and search space set of resource table 124 according to first option 204, second option 206, or third option 208. The various options provide flexibility in mapping the CCE offset indicator according to a desired scheduling criteria.

In the first option 204, each of the CCs related to each of the one or more mcDCI are associated with a same CCE offset indicator. In other words, each mcDCI of the one or more mcDCI maps to a single CCE offset indicator, such that each mcDCI is not represented by more than one CCE offset indicator.

In the second option 206, each combination of CCs related to the one or more mcDCI are associated with a single CCE offset indicator. In other words, a single CCE offset indicator is mapped to each scheduled cell group. For example, each scheduled cell group (e.g., CC1, CC2) of resource table 124 is associated with a single CCE offset indicator (e.g., 1), and the CCE offset indicator can be configured independently for each scheduled cell group.

In the third option 208, each of the CCs related to each of the one or more mcDCI are associated with a single CCE offset indicator. In other words, a different CCE offset indicator may be configured for each CC of the set of CCs. As such, the mcDCI can schedule a group of CCs together according to a criteria. For example, the criteria can be frequency range (e.g., frequency range 1 or frequency range 2) where CCs of a same frequency range have the same CCE offset indicator. In other aspects, the criteria can be related to a common location of the CCs, signal quality of the CCs, loading of the CCs or the like.

Aspects of the first option 204, the second option 206, and the third option 208 are described further herein.

The mcDCI and the CCs of the first option 204, the second option 206, and the third option 208 can be associated with one or more search space sets. As such, the BS 112 can configure a mapping of the one or more search space sets for the multi-cell configuration data according to the following criteria. A single search space set can be configured for each of the one or more mcDCI. For example, the SSS ID column of resource table 124 would indicate a single SSS ID per row. Multiple search space set can be configured for each of the one or more mcDCI. For example, SSS ID 1 and SSS ID 2 of resource table 124 corresponding to a mcDCI of signal 106. Multiple search space set can be common for all of the cell groups. For example, the SSS ID column of resource table 124 would reflect the same set of search space sets. Multiple mcDCI of the one or more mcDCI can correspond to respective scheduled cell groups, where each cell group corresponds to one or more search space set configurations. For example, signal 106 may include a first mcDCI in first search space set 108 that corresponds to a scheduled cell group with one or more search space sets, and signal 106 may include a second mcDCI in second search space set 110 that corresponds to a different scheduled cell group with one or more search space set. A common search space set can be configured for a cell group of the scheduled cells. For example, the SSS ID column of resource table 124 can indicate a common search space set. One or more search space sets of the one or more mcDCI may be configured with search space set related to cross-carrier scheduling. For example, a cell group of resource table 124 may include the scheduling cell (e.g., CC0 of BS 112), and an SSS ID associated with the scheduling cell is also the SSS ID for the cell group that includes the scheduling cell. In this aspect, the search space configuration associated with the scheduling cell may include a field that indicates an SSS ID is configured for multi-cell scheduling.

A number of PDCCH candidates per aggregation level are configured on a per search space set basis under the first option 204, the second option 206, and the third option 208. For example, the first search space set 108 can be configured with the number of PDCCH candidates that correspond to the CCE resources determined from resource table 124. As such, the multi-cell configuration data communicated in 104 can indicate a number of PDCCH candidates at an associated aggregation level or this parameter may be determined based on some criteria as will be described below.

In a first aspect, the number of PDCCH candidates per aggregation level can be configured based on one or more scheduled cells, such as CC1 and CC2. The number of PDCCH candidates per aggregation level can be configured independently for each scheduled cell of the one or more scheduled cells. In some examples, the configurations of the number of PDCCH candidates per aggregation level for the one or more scheduled cells are the same. The number of PDCCH candidates per aggregation level can be configured based on a single cell of a cell group of the one or more scheduled cells. The number of PDCCH candidates can be determined based on the configurations of a cell group of the one or more scheduled cells. For example, the number of PDCCH candidates per aggregation level can be determined based on the configuration of the cell corresponding to an index (e.g., lowest) of the configured cells of the cell group or an index (e.g., lowest) of activated cells of the cell group. The first aspect provides flexibility in configuring the number of PDCCH candidates per aggregation level at the cost of complexity due to potentially conflicting configurations of the one or more scheduled cells. The first aspect can be used for determining the number of PDCCH candidates per aggregation level for the first option 204 and the third option 208.

In a second aspect, the number of PDCCH candidates per aggregation level can be configured based on the scheduling cell. Alternatively, the number of PDCCH candidates per aggregation level can be based on a number of PDCCH candidates per aggregation level parameter or number of PDCCH candidates per aggregation level indication communicated in an L1 message or associated with the multi-cell configuration data. The second aspect provides simplicity in scheduling that avoids the complexity of handling potentially conflicting configurations of the one or more scheduled cells. The second aspect can be used for determining the number of PDCCH candidates per aggregation level for the first option 204, the second option 206, or the third option 208. For the second option 206, the number of PDCCH candidates per aggregation level can be configured independently for a cell group of the one or more candidate cells, for each SSS ID, for each set of search space set (e.g., SSS ID 1 and SSS ID 2 of resource table 124), or for each CCE offset indicator.

FIGS. 3A and 3B show example scenarios to demonstrate per cell limits for blind decodes and CCE resources for multi-cell resource scheduling. Aspects FIGS. 3A and 3B are applicable to FIG. 1 and FIG. 2 including the first option 204, the second option 206, and the third option 208. FIGS. 3A and 3B illustrate a set of scheduled cells 302 including CC0 through CC3. In both scenarios, a mcDCI 304 may schedule data with respect to CC0, CC1, CC2, and/or CC3. In a second scenario illustrated in FIG. 3B, in addition to the mcDCI 304, two scDCIs 306, 310 may schedule data with respect to CC0 and CC2, respectively. The scheduling cell for both mcDCI and scDCI can be CC0 in these scenarios.

The one or more PDCCH candidates are configured as constrained by a multi-cell blind decoding limit and a multi-cell CCE limit on a per scheduled cell basis. For the purposes of evaluating the multi-cell blind decoding limit and the multi-cell CCE limit (hereinafter the “mc BD/CCD limits”), the number of blind decodes and CCEs are counted for all active PDCCH candidates associated with mcDCIs and scDCIs that can be used to schedule the scheduled cell.

The mc BD/CCE limits (as distinguished from single-cell or legacy BD/CCE limits) can be configured by the BS 112 according to the following criteria. The mc BD/CCE limits can be based on one or more of a configured SCS, a scalar of single-cell BD/CCE limits (e.g. legacy limits associated with scDCI), or a predefined limit (e.g., mc BD/CCE limits).

In one aspect, the mc BD/CCE limits can be determined by the UE 102 and communicated to the BS 112 in a UE 102 capability report. The UE 102 may determine and report the mc BD/CCE limits using a scalar of single-cell or legacy limits, which may be reported separately for each configured SCS, each frequency range, or a combination thereof.

For example, in FIG. 3A, mcDCI is configured but no scDCI is configured. For evaluating the mc BD/CCE limits for CC0, a number of blind decodes and CCEs configured for CC0 in mcDCI 304 are tallied. In FIG. 3B, for evaluating the mc BD/CCE limits for CC0, the number of blind decodes and CCEs configured for CC0 in mcDCI 304 are added to the number of blind decodes and CCEs configured for CC0 in scDCI 306.

Referring to resource table 124 of FIG. 1, for CC1, the number of configured blind decoding instances and configured CCE resources corresponding to both SSS ID 1 and SSS ID 2 are configured to satisfy the multi-cell blind decoding limit and the multi-cell CCE limit. Additionally, CC0, CC2, and CC3 follow the per cell limits according to associated scheduled search space set.

In another example shown in FIG. 3B, the set of scheduled cells 302 has mcDCI 304, scDCI 306, and scDCI 310 configured. In some aspects, the mcDCI can be configured with a single search space set and a single CCE offset indicator for all of the CC. For example, the mcDCI can be associated with SSS ID 0, CCE offset indicator 1 for CC0-CC3. Additionally, the UE 102 can configure scDCI 306 according to self-scheduling where scDCI 306 is associated with CC0 using SSS ID 1. Furthermore, the UE 102 can be configured with cross-carrier scheduling for scDCI 310 associated with CC2 and SSS ID 2. In this example, the number of CCE resources and the number of blind decodes are configured according to the per cell limits as described below. For CC0, the number of blind decodes and CCEs corresponding to SSS ID 0 (for mcDCI 304) and SSS ID 1 (for scDCI 306) do not exceed the per cell limit of CC0 for the mc BD/CCE limits. For CC2, the number of blind decodes and CCEs corresponding to SSS ID 0 (for mcDCI 304) and SSS ID 2 (for scDCI 310) do not exceed the per cell limit of CC2 for the mc BD/CCE limits. For CC1 and CC3, the number of blind decodes and CCEs corresponding to SSS ID 0 (for mcDCI 304) do not exceed the per cell limit of CC1 and CC3 for respective mc BD/CCE limits.

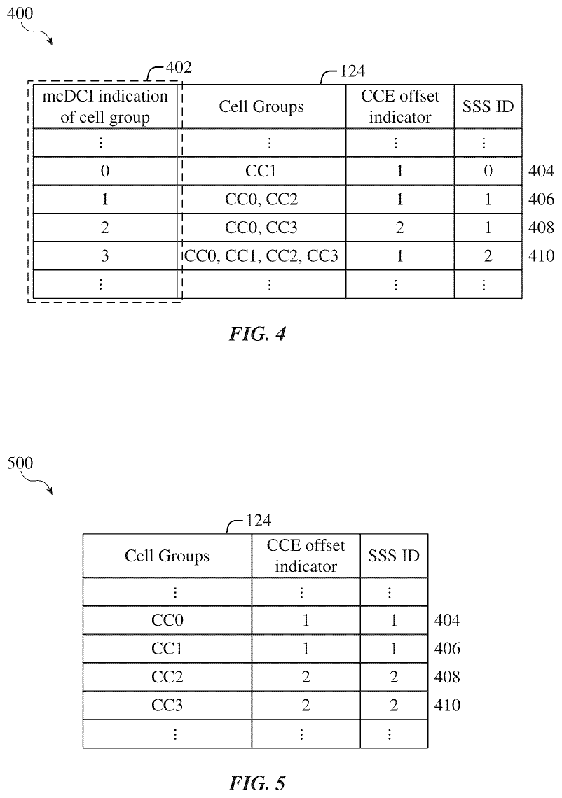

As such, the per cell limits of the one or more scheduled cells for blind decodes and CCEs can be configured to accommodate mcDCI only, or both mcDCI and scDCI. FIGS. 3A and 3B are revisited herein for additional examples in accordance with FIGS. 4-5.

FIG. 4 shows an example mapping diagram 400 of cell groups, CCE offset indicators, and search space sets according to the second option 206 of FIG. 2 for CCE offset indicator mapping. Example mapping diagram 400 shows an alternative aspect of the resource table 124 relative to FIG. 1. For each row of the resource table 124, where a cell group includes more than one CC, the UE 102 can be configured, through multi-cell configuration data, to schedule less than all the cells of a corresponding cell group. For example, the UE 102 can schedule only CC2 of row 406 comprising CC0 and CC2 or a subgroup for a row, for example, only CC0-CC2 of row 410 comprising CC0-CC3. In accordance with the second option 206, a single CCE offset indicator is mapped to different combinations of CCs related to the one or more mcDCI. While each row of resource table 124 reflects one SSS ID, it is understood that rows of resource table 124 can include more than one SSS ID or a common search space set. While the UE 102 can be configured with a subset of CCs from a row of resource table 124, the UE 102 can also be scheduled with all of the CCs from a row of resource table 124. When the UE 102 is scheduled with all of the CCs from a row of resource table 124, the row can optionally be indicated by an indication of a cell group represented by the mcDCI indication of cell group 402 column of FIG. 4. As such, by configuring the mcDCI indication of cell group 402 column, the UE 102 can be notified of a configured row (e.g. rows 404, 406, 408, or 410) with a single indicator (e.g., 0-3).

The mc BD/CCE limits can be determined for resource table 124 of FIG. 4 according to the set of scheduled cells 302 of FIG. 3B as related to the second option 206 of FIG. 2. In this example, the mcDCI 304, scDCI 306, and scDCI 310 monitoring is configured where the mcDCI monitoring is configured according to the resource table 124 of FIG. 4. Additionally, the UE 102 can configure scDCI 306 according to self-scheduling where scDCI 306 is associated with CC0 using SSS ID 3. Furthermore, the UE 102 can be configured with cross-carrier scheduling for scDCI 310 associated with CC2 and SSS ID 4. In this example, the number of CCE resources and the number of blind decoding instances are scheduled according to the mc BD/CCE limits as described below.

For CC0, the number of blind decodes and CCEs corresponding to SSS ID 1 with CCE offset indicators 1 and 2 (for mcDCI 304 at rows 406 and 408), SSID 2 with CCE offset indicator 1 (for mcDCI 304 at row 410), and SSS ID 3 (for scDCI 306) do not exceed the per cell limit of CC0 for the mc BD/CCE limits. For CC1, the number of blind decodes and CCEs corresponding to SSS ID 0 with CCE offset indicator 1 (for mcDCI 304 at row 404) and SSS ID 2 with CCE offset indicator 1 (for mcDCI 304 at row 410) do not exceed the per cell limit of CC1 for the mc BD/CCE limits. For CC2, the number of blind decodes and CCEs corresponding to SSS ID 1 with CCE offset indicator 1 (for mcDCI 304 at row 406), SSS ID 2 with CCE offset indicator 1 (for mcDCI 304 at row 410), and SSS ID 4 (for scDCI 310) do not exceed the per cell limit of CC2 for mc BD/CCE limits. For CC3, the number of blind decodes and CCEs corresponding to SSS ID 1 with CCE offset indicator 2 (for mcDCI 304 at row 408) and SSS ID 2 with CCE offset indicator 1 (for mcDCI 304 at row 410) do not exceed the per cell limit of CC3 for the mc BD/CCE limits.

FIG. 5 shows an example mapping diagram 500 of cell groups, CCE offset indicators, and search space sets according to the third option 208 of FIG. 2 for CCE offset indicator mapping. Example mapping diagram 500 shows an alternative aspect of the resource table 124 relative to FIGS. 1 and 4. The example mapping diagram 500 shows each CC configured by a single CCE offset indicator.

The mc BD/CCE limits can be determined for resource table 124 of FIG. 5 according to the set of scheduled cells 302 of FIG. 3B as related to the third option 208 of FIG. 2. In this example, the mcDCI 304, scDCI 306, and scDCI 310 are monitored where the mcDCI monitoring is configured according to the resource table 124 of FIG. 5. Additionally, the UE 102 can configure scDCI 306 according to self-scheduling where scDCI 306 is associated with CC0 using SSS ID 3. Furthermore, the UE 102 can be configured with cross-carrier scheduling for scDCI 310 associated with CC2 and SSS ID 4. In this example, the number of CCEs and the number of blind decodes are scheduled according to the per cell limits as described below.

For CC0, the number of blind decodes and CCEs corresponding to SSS ID 1 with CCE offset indicator 1 (for mcDCI 304 at row 404) and SSS ID 3 (for scDCI 306) do not exceed the per cell limit of CC0 for mc BD/CCE limits. For CC1, the number of blind decodes and CCEs corresponding to SSS ID 1 with CCE offset indicator 1 (for mcDCI 304 at row 406) does not exceed the per cell limit of CC1 for the mc BD/CCE limits. For CC2, the number of blind decodes and CCEs corresponding to SSS ID 2 with CCE offset indicator 2 (for mcDCI 304 at row 408) and SSS ID 4 (for scDCI 310) do not exceed the per cell limit of CC2 for the mc BD/CCE limits. For CC3, the number of blind decodes and CCEs corresponding to SSS ID 2 with CCE offset indicator 2 (for mcDCI 304 at row 410) does not exceed the per cell limit of CC3 for the mc BD/CCE limits.

Aspects described in accordance with FIGS. 3-5 provide examples of configuring blind decodes and CCEs according to the mc BD/CCE limits for the first option 204, the second option 206, and the third option 208 for CCE offset indicator mapping. The examples provide solutions for mcDCI or mcDCI and scDCI monitoring and per cell limits to manage the amount of time the UE 102 spends performing decoding of the one or more PDCCH candidates.

Additionally, the BS 112 configures each of the one or more mcDCI in signal 106 with a mcDCI size. The mcDCI size of each of the one or more mcDCI associated with FIGS. 1-2, 3A, 3B, and 4-5 can be configured according to the examples provided below. In a first example, the one or more mcDCI can be configured with a same mcDCI size. In a second example, the one or more mcDCI are configured with one or more mcDCI sizes based on a mapping of the one or more mcDCI sizes, search space sets, and CCE offset indications. In the second example, a size of each DCI field in a mcDCI can be determined based on the configurations of the cells in the cell group configured with a same search space set and a same CCE offset indication. For both the first example, and the second example, the one or more mcDCI sizes collectively satisfy a DCI size budget.

Aspects presented herein provide flexibility and spectral efficiency by minimizing signaling overhead to schedule multi-cell communications by use of the mcDCI and multi-cell scheduling configuration.

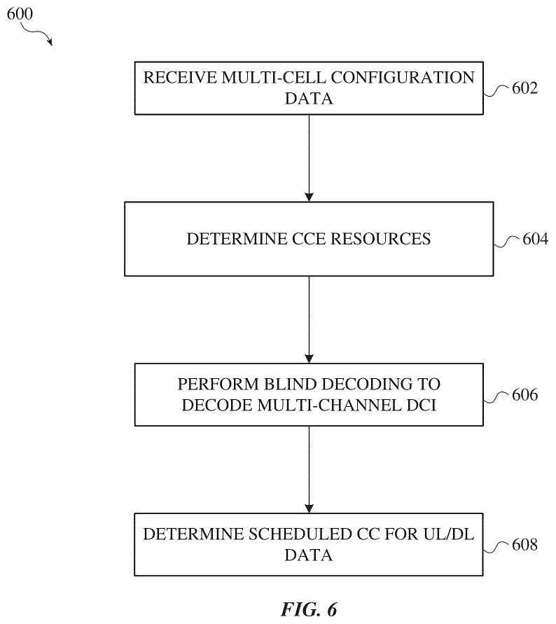

FIG. 6 is a flow diagram outlining an example method 600 by which a UE can configure multi-cell communications. The example method 600 may be performed, for example, by the UE 102 of FIG. 1

At 602, the method includes receiving multi-cell configuration data. The multi-cell configuration data can configure CCE offset indicators mapped to respective search space sets and respective CCs, where each CC is associated with a scheduled cell of one or more scheduled cells. The multi-cell configuration data can be received in RRC signaling.

At 604, the method includes determining CCE resources based, at least partially on the CCE offset indicators. The CCE resources are related to one or more PDCCH candidates, where the one or more PDCCH candidates are associated with respective search space sets.

At 606, the method includes performing blind decoding of the one or more PDCCH candidates to decode one or more mcDCI transmitted by a scheduling CC or a scheduling cell. The blind decoding can be configured according to a multi-cell blind decoding limit, and the CCE resources can be configure according to a multi-cell CCE limit, where the limits are per cell limits of the set of CCs. The number of blind decodes and the number of CCE resources can be based on the one or more mcDCI and one or more mcSCI.

At 608, the method includes determining, from the one or more mcDCI, UL/DL CCs. The method can optionally configure UL/DL signaling according to the UL/DL CCs.

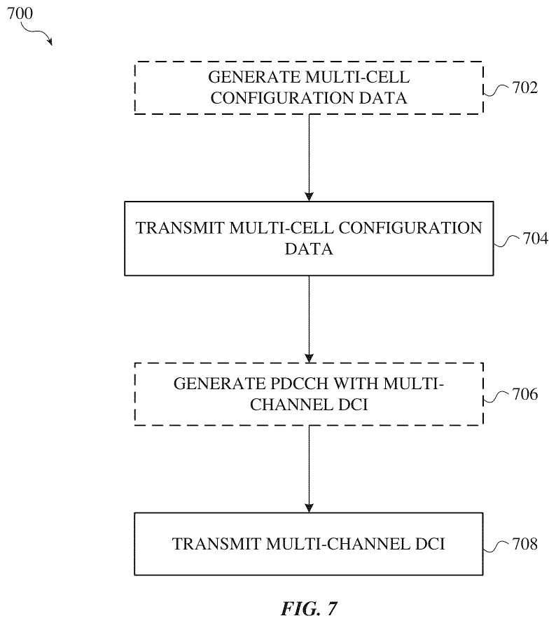

FIG. 7 is a flow diagram outlining an example method 700 by which a BS can configure multi-cell communications. The example method 700 may be performed, for example, by the BS 112 of FIG. 1

At 702, the method includes optionally generating multi-cell configuration data. The multi-cell configuration data can configure CCE offset indicators mapped to respective search space sets and respective CCs, where each CC is associated with a scheduled cell of one or more scheduled cells.

At 704, the method includes transmitting the multi-cell configuration data. The multi-cell configuration data can be transmitted in RRC signaling.

At 706, the method includes optionally generating one or more PDCCH with respective one or more mcDCI. The PDCCH can be generated according to a multi-cell blind decode limit and a CCE limit and according to the search space set of the multi-cell configuration data.

At 708, the method includes transmitting the PDCCH with the mcDCI.

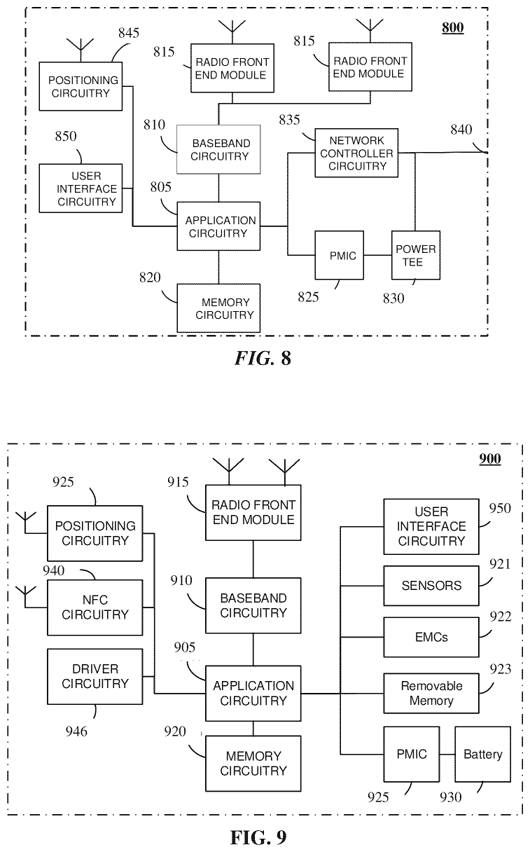

FIG. 8 illustrates an example of infrastructure equipment 800 in accordance with various aspects. The infrastructure equipment 800 (or “system 800”) may be implemented as a base station, radio head, radio access network (RAN) node such as the BS 112 of FIG. 1 and/or any other element/component/device discussed herein. In other examples, the system 800 could be implemented in or by a UE such as UE 102, of FIG. 1.

The system 800 includes application circuitry 805, baseband circuitry 810, one or more radio front end modules (RFEMs) 815, memory circuitry 820 (including a memory interface), power management integrated circuitry (PMIC) 825, power tee circuitry 830, network controller circuitry 835, network interface connector 840, satellite positioning circuitry 845, and user interface 850. In some aspects, the device of system 800 may include additional elements/components/devices such as, for example, memory/storage, display, camera, sensor, or input/output (I/O) interface. In other aspects, the components/devices described below may be included in more than one device. For example, said circuitries may be separately included in more than one device for CRAN, vBBU, or other like implementations.

Application circuitry 805 includes circuitry such as, but not limited to one or more processors (or processor cores), processing circuitry, cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 805 may be coupled with or may include memory/storage elements/components/devices and may be configured to execute instructions stored in the memory/storage to enable various applications or operating systems to run on the system 800. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 805 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more field programmable gate array (FPGAs), one or more PLDs, one or more application-specific integrated circuits (ASICs), one or more microprocessors or controllers, or any suitable combination thereof. In some aspects, the application circuitry 805 may comprise, or may be, a special-purpose processor/controller to operate according to the various aspects herein. As examples, the processor(s) of application circuitry 805 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 800 may not utilize application circuitry 805, and instead may include a special-purpose processor/controller to process IP data received from an EPC or 5GC, for example.

User interface 850 may include one or more user interfaces designed to enable user interaction with the system 800 or peripheral component or device interfaces designed to enable peripheral component or device interaction with the system 800. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component or device interfaces may include, but are not limited to, a nonvolatile memory port, a universal serial bus (USB) port, an audio jack, a power supply interface, etc.

The components or devices shown by FIG. 8 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

FIG. 9 illustrates an example of a platform 900 (or “device 900”) in accordance with various aspects. In aspects, the platform 900 may be suitable for use as the UE 102 of FIG. 1, and/or any other element/component/device discussed herein such as the BS 112 of FIG. 1. The platform 900 may include any combinations of the components or devices shown in the example. The components or devices of platform 900 may be implemented as integrated circuits (ICs), portions thereof, discrete electronic devices, or other modules, logic, hardware, software, firmware, or a combination thereof adapted in the platform 900, or as components or devices otherwise incorporated within a chassis of a larger system. The block diagram of FIG. 9 is intended to show a high level view of components or devices of the platform 900. However, some of the components or devices shown may be omitted, additional components or devices may be present, and different arrangement of the components or devices shown may occur in other implementations.

Application circuitry 905 includes circuitry such as, but not limited to one or more processors (or processor cores), memory circuitry 920 (which includes a memory interface), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 905 may be coupled with or may include memory/storage elements/component/device and may be configured to execute instructions stored in the memory/storage to enable various applications or operating systems to run on the system 900. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

As examples, the processor(s) of application circuitry 905 may include a general or special purpose processor, such as an A-series processor (e.g., the A13 Bionic), available from Apple® Inc., Cupertino, CA or any other such processor. The processors of the application circuitry 905 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 905 may be a part of a system on a chip (SoC) in which the application circuitry 905 and other components or devices are formed into a single integrated circuit, or a single package.

The baseband circuitry or processor 910 may be implemented, for example, as a solder-down substrate including one or more integrated circuits, a single packaged integrated circuit soldered to a main circuit board or a multi-chip module containing two or more integrated circuits. Furthermore, the baseband circuitry or processor 910 may cause transmission of various resources.

The platform 900 may also include interface circuitry (not shown) that is used to connect external devices with the platform 900. The interface circuitry may communicatively couple one interface to another. The external devices connected to the platform 900 via the interface circuitry include sensor circuitry 921 and electro-mechanical components (EMCs) 922, as well as removable memory devices coupled to removable memory circuitry 923.

A battery 930 may power the platform 900, although in some examples the platform 900 may be mounted deployed in a fixed location, and may have a power supply coupled to an electrical grid. The battery 930 may be a lithium ion battery, a metal-air battery, such as a zinc-air battery, an aluminum-air battery, a lithium-air battery, and the like. In some implementations, such as in V2X applications, the battery 930 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium or a non-transitory computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components or devices, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a baseband processor of a user equipment (UE), comprising: a memory; and one or more processors configured to, when executing instructions stored in the memory, cause the UE to receive radio resource control (RRC) signaling configuring control channel element (CCE) offset indicators mapped to respective search space sets and respective component carriers (CCs), each CC associated with a scheduled cell of one or more scheduled cells; determine, based on the RRC signaling, CCE resources associated with one or more physical downlink control channel (PDCCH) candidates; perform blind decoding of the one or more PDCCH candidates to decode one or more multi-cell downlink control information (mcDCI) transmitted by a scheduling cell; and determine, from the one or more mcDCI, uplink (UL)/downlink (DL) CCs.

Example 2 includes Example 1, wherein each of the CCs related to each of the one or more mcDCI are associated with a same CCE offset indicator.

Example 3 includes Example 1, wherein each combination of CCs related to the one or more mcDCI are associated with a single CCE offset indicator.

Example 4 includes Example 1, wherein each of CCs related to each of the one or more mcDCI are associated with a single CCE offset indicator.

Example 5 includes any of Examples 1-4, wherein a single search space set is configured for each of the one or more mcDCI, or multiple search space sets are configured for each of the one or more mcDCI, or a common search space set is configured for a cell group of the scheduled cells.

Example 6 includes any of Examples 1-4, wherein a number of PDCCH candidates of the one or more PDCCH candidates are configured for an aggregation level corresponding to the search space sets, and the number of PDCCH candidates is configured based on one or more scheduled cells or a scheduling cell.

Example 7 includes Example 6, wherein the number of PDCCH candidates is configured independently for each scheduled cell of the one or more scheduled cells.

Example 8 includes Example 6, wherein the number of PDCCH candidates is configured on a single cell of a cell group of the one or more scheduled cells.

Example 9 includes Example 6, wherein the number of PDCCH candidates is based on a cell group of the one or more scheduled cells, and each of the cells of the cell group are configured with the number of PDCCH candidates.

Example 10 includes Example 6, wherein the number of PDCCH candidates is based on a selected one of the cells of a cell group of the one or more scheduled cells according to a rule.

Example 11 includes Example 10, wherein the rule is based on an index of configured cells of the cell group or the rule is based on an index of activated cells of the cell group.

Example 12 includes Example 6, wherein the number of PDCCH candidates is configured on a scheduling cell.

Example 13 includes any of Examples 1-4, wherein the one or more PDCCH candidates are configured according to a multi-cell blind decoding limit for one or more cells of the scheduled cells and wherein the CCE resources are configured according to a multi-cell CCE for one or more cells of the scheduled cells.

Example 14 includes Example 13, wherein the multi-cell blind decoding limit and the multi-cell CCE limit are based on one or more of a subcarrier spacing (SCS), a scalar of a single-cell blind decoding or CCE limit, or a predefined limit.

Example 15 includes Example 13, wherein the one or more processors are further configured to determine the multi-cell blind decoding limit and the multi-cell CCE limit, and transmit a report with the multi-cell blind decoding limit and the multi-cell CCE limit.

Example 16 includes Example 15, wherein the report is generated based on one or more of a configured subcarrier spacing (SCS), a frequency range, or the one or more scheduled cells.

Example 17 includes any of Examples 13-16 wherein the multi-cell blind decoding limit for a scheduled cell of the one or more scheduled cells corresponds to a number of blind decoding of the one or more mcDCI and a number of blind decoding of one or more single-channel DCI (scDCI); and the multi-cell CCE limit for the scheduled cell corresponds to a number of CCE resources of the one or more mcDCI and a number of CCE resources of the one or more scDCI.

Example 18 includes Example 17, wherein the one or more mcDCI or one or more scDCI schedule the scheduled cell.

Example 19 includes any of Examples 1-4, wherein the one or more mcDCI are configured with a same mcDCI size.

Example 20 includes any of Examples 1-4, wherein the one or more mcDCI are configured with one or more mcDCI sizes based on a mapping of the one or more mcDCI sizes, search space sets, and CCE offset indications.

Example 21 includes Example 20, wherein the one or more scheduled cells comprise cell groups configured with a same search space set and a same CCE offset indication, and each of the one or more mcDCI are configured with a mcDCI size of the one or more mcDCI sizes based on a mapping to each of the cell groups.

Example 22 includes any of Examples 20-21, wherein the one or more mcDCI sizes collectively satisfy a DCI size budget.

Example 23 is a baseband processor of a base station (BS), comprising: a memory; and one or more processors configured to, when executing instructions stored in the memory, cause the BS: generate radio resource control (RRC) signaling that configures control channel element (CCE) offset indicators mapped to respective search space sets and respective component carriers (CCs), each CC associated with a scheduled cell, and CCE offset indicators associated with CCE resources, wherein the CCE offset indicators and CCs are related to one or more physical downlink control channel (PDCCH) candidates, the one or more PDCCH candidates comprising one or more multi-cell downlink control information (mcDCI); and transmit a radio resource control (RRC) signal comprising the mapping of the CCE offset indicators, CCs, and search space sets.

Example 24 includes Example 23, wherein the one or more processors are further configured to: generate the one or more mcDCI related to uplink (UL)/downlink (DL) CCs, wherein the mcDCI is configured with a blind decoding limit and a CCE limit; and transmit the one or more mcDCI in one or more PDCCH candidates.

Example 25 includes any of Examples 23-24, wherein each of the CCs related to each of the one or more mcDCI are associated with a same CCE offset indicator.

Example 26 includes any of Examples 23-24, wherein each combination of CCs related to the one or more mcDCI are associated with a single CCE offset indicator.

Example 27 includes any of Examples 23-24, wherein each of CCs related to each of the one or more mcDCI are associated with a single CCE offset indicator.

Example 28 includes any of Examples 23-27, wherein a single search space set is configured for each of the one or more mcDCI, or multiple search space sets are configured for each of the one or more mcDCI, or a common search space set is configured for a cell group of the scheduled cells.

Example 29 includes any of Examples 23-27, wherein a number of PDCCH candidates of the one or more PDCCH candidates are configured for an aggregation level corresponding to the search space sets, and the number of PDCCH candidates is configured based on one or more scheduled cells or a scheduling cell.

Example 30 includes Example 29, wherein the number of PDCCH candidates is configured independently for each scheduled cell of the one or more scheduled cells.

Example 31 includes Example 29, wherein the number of PDCCH candidates is configured on a single cell of a cell group of the one or more scheduled cells.

Example 32 includes Example 29, wherein the number of PDCCH candidates is based on a cell group of the one or more scheduled cells, and each of the cells of the cell group are configured with the number of PDCCH candidates.

Example 33 includes Example 29 wherein the number of PDCCH candidates is based on a selected one of the cells of a cell group of the one or more scheduled cells according to a rule.

Example 34 includes Example 33, wherein the rule is based on an index of configured cells of the cell group or the rule is based on an index of activated cells of the cell group.

Example 35 includes Example 29, wherein the number of PDCCH candidates is configured on a scheduling cell.

Example 36 includes Example 24, wherein the one or more PDCCH candidates are configured according to a multi-cell blind decoding limit for one or more cells of the scheduled cells and wherein the CCE resources are configured according to a multi-cell CCE for one or more cells of the scheduled cells.

Example 37 includes Example 36, wherein the multi-cell blind decoding limit and the multi-cell CCE limit are based on one or more of a subcarrier spacing (SCS), a scalar of a single-cell blind decoding or CCE limit, or a predefined limit.

Example 38 includes Example 36, wherein the multi-cell blind decoding limit for a scheduled cell of the one or more scheduled cells corresponds to a number of blind decoding of the one or more mcDCI and a number of blind decoding of one or more single-channel DCI (scDCI); and the multi-cell CCE limit for the scheduled cell corresponds to a number of CCE resources of the one or more mcDCI and a number of CCE resources of the one or more scDCI.

Example 39 includes Example 38, wherein the one or more mcDCI or one or more scDCI schedule the scheduled cell.

Example 40 includes any of Examples 23-27, wherein the one or more mcDCI are configured with a same mcDCI size.

Example 41 includes any of Examples 23-27, wherein the one or more mcDCI are configured with one or more mcDCI sizes based on a mapping of the one or more mcDCI sizes, search space sets, and CCE offset indications.

Example 42 includes Example 41, wherein the one or more scheduled cells comprise cell groups configured with a same search space set and a same CCE offset indication, and each of the one or more mcDCI are configured with a mcDCI size of the one or more mcDCI sizes based on a mapping to each of the cell groups.

Example 43 includes any of Examples 41 or 42, wherein the one or more mcDCI sizes collectively satisfy a DCI size budget.

Example 44 is a user equipment (UE), comprising: a memory; and one or more processors configured to, when executing instructions stored in the memory, cause the UE to receive radio resource control (RRC) signaling configuring control channel element (CCE) offset indicators mapped to respective search space sets and respective component carriers (CCs), each CC associated with a scheduled cell of one or more scheduled cells; determine, based on the RRC signaling, CCE resources associated with one or more physical downlink control channel (PDCCH) candidates; perform blind decoding of the one or more PDCCH candidates to decode one or more multi-cell downlink control information (mcDCI) transmitted by a scheduling cell; and determine, from the one or more mcDCI, uplink (UL)/downlink (DL) CCs.

A method as substantially described herein with reference to each or any combination substantially described herein, comprised in examples 1-44, and in the Detailed Description.

A non-transitory computer readable medium as substantially described herein with reference to each or any combination substantially described herein, comprised in examples 1-44, and in the Detailed Description.

A wireless device configured to perform any action or combination of actions as substantially described herein, comprised in examples 1-44, and in the Detailed Description.

An integrated circuit configured to perform any action or combination of actions as substantially described herein, comprised in examples 1-44, and in the Detailed Description.

An apparatus configured to perform any action or combination of actions as substantially described herein, comprised in examples 1-44, and in the Detailed Description.

A baseband processor configured to perform any action or combination of actions as substantially described herein, comprised in examples 1-44, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components or devices (assemblies, devices, circuits, systems, etc.), the terms (including a reference to a “means”) used to describe such components or devices are intended to correspond, unless otherwise indicated, to any component, device, or structure which performs the specified function of the described component or device (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements, devices, or components throughout, and wherein the illustrated structures and devices are not necessarily drawn to scale. As utilized herein, terms “device,” “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor of a user equipment (UE), comprising
one or more processors configured to cause the UE to:
receive radio resource control (RRC) signaling comprising at least one control channel element (CCE) offset indicator mapped to a respective search space set and a respective component carrier (CC) associated with a scheduled cell of one or more scheduled cells;
determine, based on the CCE offset indicator, CCE resources associated with one or more physical downlink control channel (PDCCH) candidates;
perform blind decoding of the one or more PDCCH candidates to decode one or more multi-cell downlink control information (mcDCI) transmitted by a scheduling cell; and
determine, from the one or more mcDCI, uplink (UL)/downlink (DL) CCs.

2. The baseband processor of claim 1, wherein the respective component carrier is one of a plurality of CCs that are respectively related to each of the one or more mcDCI, and the plurality of CCs are associated with a same CCE offset indicator.

3.-5. (canceled)

6. The baseband processor of claim 1, wherein a number of PDCCH candidates of the one or more PDCCH candidates are configured for an aggregation level corresponding to search space sets that includes the search space set, and the number of PDCCH candidates are configured based on the one or more scheduled cells or the scheduling cell.

7. The baseband processor of claim 6, wherein the number of PDCCH candidates is configured independently for each scheduled cell of the one or more scheduled cells, or
the number of PDCCH candidates is configured on a single cell of a cell group of the one or more scheduled cells.

8. (canceled)

9. The baseband processor of claim 6, wherein the number of PDCCH candidates is based on a cell group of the one or more scheduled cells, and each of the cells of the cell group are configured with the number of PDCCH candidates.

10.-44. (canceled)

45. The baseband processor of claim 1, wherein the one or more mcDCI are multiple mcDCIs that correspond to different cell groups of the one or more scheduled cells, wherein each cell group corresponds to a different search space set.

46. The baseband processor of claim 1, wherein the received RRC signaling includes one or more search space set IDs, wherein
one or more search space sets are mapped to the one or more scheduled cells according to the one or more search space set IDs; and
the one or more search space sets are mapped to the one or more mcDCI by the one or more search space set IDs.

47. A user equipment (UE), comprising:
a memory; and
one or more processors configured to, when executing instructions stored in the memory, cause the UE to:
receive a radio resource control (RRC) signaling comprising at least one control channel element (CCE) offset indicator mapped to a respective search space set and a respective component carrier (CC) associated with a scheduled cell of one or more scheduled cells;
determine, based on the CCE offset indicator, CCE resources associated with one or more physical downlink control channel (PDCCH) candidates;
perform blind decoding of the one or more PDCCH candidates to decode one or more multi-cell downlink control information (mcDCI) transmitted by a scheduling cell; and
determine, from the one or more mcDCI, uplink (UL)/downlink (DL) CCs.

48. UE of claim 47, wherein a number of PDCCH candidates of the one or more PDCCH candidates are configured for an aggregation level corresponding to search space sets that include the search space sets, and the number of PDCCH candidates is configured based on one or more scheduled cells or a scheduling cell, and wherein
the number of PDCCH candidates is based on a selected one of the cells of a cell group of the one or more scheduled cells according to a rule, wherein the rule is based on an index of configured cells of the cell group or the rule is based on an index of activated cells of the cell group.

49. The UE of claim 47, wherein the one or more PDCCH candidates are configured according to a multi-cell blind decoding limit for one or more cells of the one or more scheduled cells and wherein the CCE resources are configured according to a multi-cell CCE limit for the one or more scheduled cells.

50. The UE of claim 49, wherein the multi-cell blind decoding limit and the multi-cell CCE limit are based on one or more of a subcarrier spacing (SCS), a scalar of a single-cell blind decoding or CCE limit, or a predefined limit.

51. The UE of claim 49, wherein the multi-cell blind decoding limit for a scheduled cell of the one or more scheduled cells corresponds to a number of blind decoding of the one or more mcDCI and a number of blind decoding of one or more single-channel DCI (scDCI); and the multi-cell CCE limit for the scheduled cell corresponds to a number of CCE resources of the one or more mcDCI and a number of CCE resources of the one or more scDCI.

52. The UE of claim 47, wherein the one or more mcDCI are configured with one or more mcDCI sizes based on a mapping of the one or more mcDCI sizes, search space set, and at least one CCE offset indication, and
wherein the one or more scheduled cells comprise cell groups each configured with a search space set and a CCE offset indication, and each of the one or more mcDCI are configured with a mcDCI size of the one or more mcDCI sizes based on a mapping to each of the cell groups.

53. The UE of claim 47, wherein the RRC signaling is received from the scheduling cell, wherein the scheduling cell is one of the one or more scheduled cells; and the one or more processors are further configured to:
receive the one or more PDCCH candidates from the scheduling cell.

54. The UE of claim 47, wherein the RRC signaling is received from the scheduling cell, wherein the scheduling cell is one of the one or more scheduled cells, and the RRC signaling includes a search space set ID, wherein the search space set ID maps to the mcDCI, and the search space set ID identifies both the scheduling cell and the scheduled cell.

55. A base station (BS), comprising:
a memory; and
one or more processors configured to, when executing instructions stored in the memory, cause the BS:
generate a radio resource control (RRC) signal comprising at least one control channel element (CCE) offset indicator mapped to a respective search space set and a respective component carrier (CC) associated with a scheduled cell, and a CCE offset indicator is associated with a CCE resource, wherein
the CCE offset indicator and CC are related to one or more physical downlink control channel (PDCCH) candidates, the one or more PDCCH candidates comprising one or more multi-cell downlink control information (mcDCI); and
transmit, by a radio frequency (RF) circuitry, the RRC signal comprising the mapping of the CCE offset indicators, CCs, and search space sets.

56. The BS of claim 55, wherein the one or more processors are further configured to:
generate the one or more mcDCI related to uplink (UL)/downlink (DL) CCs, wherein the one or more mcDCI are configured with a blind decoding limit and a CCE limit; and
transmit, by the RF circuitry, the one or more mcDCI in one or more PDCCH candidates.

57. The BS of claim 56, wherein the one or more PDCCH candidates are configured according to a multi-cell blind decoding limit for one or more cells of the one or more scheduled cells and wherein the CCE resources are configured according to a multi-cell CCE limit for the one or more scheduled cells.

58. The BS of claim 57, wherein the multi-cell blind decoding limit for a scheduled cell of the one or more scheduled cells corresponds to a number of blind decoding of the one or more mcDCI and a number of blind decoding of one or more single-channel DCI (scDCI); and the multi-cell CCE limit for the scheduled cell corresponds to a number of CCE resources of the one or more mcDCI and a number of CCE resources of the one or more scDCI.

59. The BS of claim 55, wherein a single search space set is configured for each of the one or more mcDCI, or multiple search space sets are configured for each of the one or more mcDCI, or a common search space set is configured for a cell group of the one or more scheduled cells.
